(19) United States
(12) Patent Application Publication
(10) Pub. No.: US 2015/0125023 A1
(43) Pub. Date: May 7, 2015

(54) HEADSET WITH VARIABLE ACOUSTIC IMPEDANCE

(71) Applicant: IdeaVillage Products Corp., Wayne, NJ (US)

(72) Inventor: Greg E. Blonder, Summit, NJ (US)

(21) Appl. No.: 14/596,376

(22) Filed: Jan. 14, 2015

Related U.S. Application Data
(63) Continuation-in-part of application No. 13/815,538, filed on Mar. 8, 2013.
(60) Provisional application No. 61/927,011, filed on Jan. 14, 2014.

(51) Int. Cl. H04R 1/10

(52) U.S. Cl. CPC H04R 1/1058
USPC 381/373

(57) ABSTRACT

A headset apparatus including a speaker housing having an acoustic impedance and configured for conversion between a first listening mode and a second listening mode by rotation of the at least one speaker housing about an axle. The headset apparatus includes at least one vent configured to alter the acoustic impedance of the at least one speaker housing. The headset apparatus also includes a valve configured to open the at least one vent in the first listening mode and configured to close at least some portion of the at least one vent in the second listening mode.

### CROSS-REFERENCE TO RELATED APPLICATIONS

This application is a continuation-in-part of U.S. patent application Ser. No. 13/815,538, filed Mar. 8, 2013, which is hereby incorporated by reference herein in its entirety. This application claims the benefit of U.S. Provisional Application No. 61/927,011, filed on Jan. 14, 2014. U.S. patent application Ser. No. 13/815,538 and U.S. Provisional Application No. 61/927,011 are both hereby incorporated by reference herein in their entireties.

### FIELD OF THE INVENTION

This invention relates to a music listening and playing apparatus and more specifically, music headphones with rotating speakers and with music listening and playing modes including a variable acoustic impedance.

### DESCRIPTION OF THE RELATED ART

Audio headsets typically include left and right speaker enclosures incorporating one or more acoustically engineered vents. These vents may be oriented along a rear edge of the enclosure on a solenoid side of a speaker cone, or on a front side of a speaker facing the ear. The vents may take the shape of a narrow slot, or a round hole at the end of a long tube, forming a “Helmholtz” resonator.

The vents are configured to adjust the acoustic performance of the speaker within the enclosure. For example, the speaker and enclosure may resonate around 2 kHz. A hole having a selected shape and location may selectively vent these frequencies, dampening the resonance and leading to a more accurate rendition of the audio. In certain instances, the vents and internal cavities within the speaker enclosure can emphasize the bass frequencies, which many listeners find desirable.

However, conventional vents are configured for audio production with the headset in a single position (e.g., over the ear). For example, for a typical headset having an annular ear cushion, any air vented from the speaker side also resonates in the volume between the speaker and the side of the user's head. However, if the enclosure were rotated outwardly to act as an amplified speaker, the user's head is no longer present, therefore the conventional venting arrangement is deficient.

### SUMMARY OF THE DISCLOSURE

In one embodiment, the present disclosure provides for a music playing and listening apparatus comprising: a headband having opposing ends; at least two connectors, each of the connectors having at least two arms, a first arm is shorter than a second arm; and at least two speakers, each of the speakers having opposing sides and comprising an audio output element on a first side and a compartment on a second side, the first and second arms of each of the connectors is pivotally attached to a portion of each of the speakers to thereby allow rotation of the speakers, each of the audio output elements of each of the speakers generally face one another during a first listening mode, each of the speakers being rotatable about the first and second arms of each of the connectors to thereby allow each of the audio output elements of each of the speakers to turn away from one another during a second listening mode; the rotation of the speakers allowing for changes in modes.

In another embodiment, the length ratio of the first arm to the second arm of each of the connectors is from about 1:1.1 to about 1:10. In yet another embodiment, the length ratio of the first arm to the second arm of each of the connectors is from about 1:1.25 to about 1:5.

In still another embodiment, each of the speakers rotates about an axis formed by the first and second arms of each of the connectors. In still yet another embodiment, each of the speakers is designed to rotate about the axes during the first listening mode at angles from about 0 degrees to about 100 degrees. In a further embodiment, each of the speakers is designed to rotate about the axes during the first listening mode at angles from about 0 degrees to about 30 degrees. In another further embodiment, each of the speakers is designed to rotate about the axes during the second listening mode at angles from about 20 degrees to greater than 180 degrees. In yet another further embodiment, the speakers are designed to rotate about the axes during the second listening mode at angles from about 30 degrees to about 170 degrees.

In still another further embodiment, the headband is generally situated over a user's head and each of the audio output elements of each of the speakers generally faces the user's ears during the first listening mode.

In still yet another further embodiment, the apparatus is situated around a user's neck and both of the speakers are designed to be rotated and allow each of the audio output elements of each of the speakers to generally face away from the user during the second listening mode.

In another embodiment, the apparatus is set on a surface and the headband is generally parallel to the surface and the speakers are designed to be rotated about the first and second arms of each of the connectors to allow the audio output elements of each of the speaker to generally face away from the surface during the second listening mode.

In yet another embodiment, the length of the second arm relative to the first arm creates an angle between the surface and at least one speaker, and the angle is greater than 1 degree and less than 90 degrees.

In still another embodiment, the length of the second arm relative to the first arm creates an angle between the surface and at least one speaker, and the angle is from about 10 degrees to about 80 degrees.

In still yet another embodiment, each of the connectors comprises a third arm rotatably attached to opposing ends of the headband.

In a further embodiment, the apparatus further comprises a safety interlocking device which is designed to limit the volume output of the speakers in the first listening mode and increases the volume output of the speakers during the second listening mode.

In yet a further embodiment, the speakers lock into place during the second listening mode.

In still a further embodiment, the apparatus further comprises at least two ear cushions, each of the cushions is attached to at least a portion of the audio output element.

In yet a further embodiment, the speakers lock into position when rotated 90 or 180 degrees, but allows for some small movement around 0 degrees (e.g. when the speaker cushion are against the ears) for better fit and comfort.

In still yet a further embodiment, the apparatus further comprises at least one amplifier, and the amplifier is connected to a portion of at least one of the speakers.

In another further embodiment, the apparatus further comprises at least one switching mechanism, and the switching mechanism is activated by rotating each of the speakers from said music listening mode to the second listening mode, and the rotation of the speakers activates the amplifier.

In yet another further embodiment, the apparatus further comprises at least one switching mechanism, and the switching mechanism is activated by rotating one of the speakers from the music playing mode to the second listening mode, and the rotation of one of the speakers deactivates the amplifier.

In still another further embodiment, at least one of the compartments of the speakers provides for storage of a power source. In still yet another further embodiment, the headband provides for storage of a power source. In another embodiment, the apparatus further comprises at least one power source, and the power source is a battery.

In yet another embodiment, the apparatus further comprises an on and off mechanism. In still another embodiment, the apparatus further comprises volume control mechanism, and the volume control mechanism controls audio output volume of the speakers. In yet another embodiment, the apparatus further comprises a cable and an adaptor. In still yet another embodiment, the headband is generally U shaped.

In a further embodiment, the apparatus further comprises a wireless receiver designed to accept audio signals from an external source.

In yet a further embodiment, the present disclosure relates to a listening apparatus comprising: a headband having opposing ends; at least two connectors, each of the connectors having at least two arms, a first arm is shorter than a second arm; at least two speakers, each of the speakers having opposing sides and comprising an audio output element on a first side and a compartment on a second side, the first and second arms of each of the connectors is pivotally attached to a portion of each of the speakers to thereby allow rotation of the speakers, each of the audio output elements of each of the speakers generally face one another during a first listening mode, each of the speakers is designed to be rotated to thereby allow each of the audio output elements of each of the speakers to turn away from one another during a second listening mode; and a safety interlocking device designed to limit the volume output of the speakers in the first listening mode and increases the volume output of said speakers during said second listening mode.

In still a further embodiment, each of the speakers rotates about an axis formed by the first and second arms of each of the connectors, each of the speakers is designed to rotate about the axis during the first listening mode at angles from about 0 degrees to about 100 degrees.

In still yet a further embodiment, each of the speakers rotate about an axis formed by the first and second arms of each of the connectors, wherein each of the speakers is designed to rotate about the axis during the second listening mode at angles from about 20 degrees to greater than 180 degrees.

In another embodiment, the present disclosure provides for a listening apparatus comprising: a headband having opposing ends; at least two connectors, each of the connectors has at least two arms, a first arm is shorter than a second arm, and the first and second arms has a length ratio of from about 1:1.1 to about 1:10; and at least two speakers, each of the speakers having opposing sides and comprising an audio output element on a first side, the first and second arms of each of the connectors is pivotally attached to a portion of each of the speakers to thereby allow rotation of the speakers, each of the audio output elements of each of the speakers generally face one another during a first listening mode, each of the speakers is designed to be rotated to thereby allow each of the audio output elements of each of the speakers to turn away from one another during a second listening mode.

In another embodiment, the present disclosure provides for a listening apparatus comprising a headband comprising two end portions, each of the end portions comprising an angled hinge having two opposing ends; and at least two speakers, each of the speakers rotatably coupled to the two ends of the angled hinged to form two rotary joints, wherein rotation of each of the speakers about a respective axis of rotation between the two rotary joints transitions the apparatus between a first listening mode and a second listening mode.

In an embodiment, the axis of rotation between the two rotary joints of a first speaker of at least two speakers extends at an angle of about 45 degrees relative to a midline axis of the first speaker. In an embodiment, the angled hinge extends at an angle of about 45 degrees relative to a midline axis of the first speaker. In an embodiment, the speakers are configured to rotate about the axis of rotation during the first listening mode in a range of about 0 degrees to about 100 degrees. In an embodiment, the angled hinge and each of the two rotary joints of a first speaker of the at least two speakers substantially limit rotational motion of the two rotary joints to pivot through a substantially circular arc around the respective axis of rotation.

### BRIEF DESCRIPTION OF THE DRAWINGS

The accompanying drawings are included to provide a further understanding of the present disclosure. These drawings are incorporated in and constitute a part of this specification, illustrate one or more embodiments of the present disclosure and together with the description, serve to explain the principles of the present disclosure.

FIG. 1 is a perspective view of the apparatus of the present disclosure in a music listening mode on a user's head;

FIG. 2 is a perspective view of the apparatus of FIG. 1 in a music playing mode around a user's neck;

FIG. 3 is a perspective view of the apparatus of FIG. 1 in a music playing mode when the apparatus is place on a surface;

FIG. 4a-c are perspective side view of the apparatus showing the rotation of the speakers;

FIG. 5a-b are views of the apparatus showing the angles created by the rotation;

FIG. 6 is view of the apparatus in FIG. 3 showing how the differing length of the arms create angles between the speaker and the surface;

FIG. 7a-b are schematic view of one of the embodiments of the switch mechanism;

FIG. 8 is a perspective view of an exemplary apparatus including at least one vent configured to alter the acoustic impedance of at least one speaker housing, according to aspects of the present disclosure;

FIG. 9 is a perspective view of an exemplary apparatus including a rotary joint configured to enable a mechanically actuated valve an angled hinge, according to aspects of the present disclosure;

FIG. 10 is a perspective view of an exemplary apparatus including a speaker movable to expose an otherwise hidden and sealed vent including an angled hinge, according to aspects of the present disclosure; and

FIGS. 11A and 11B depict perspective views of an exemplary apparatus including a speaker that may be transitioned from a headset configuration to a speaker configuration, wherein placement into the speaker configuration exposes a vent for adjustment of the acoustic impedance of the speaker, according to aspects of the present disclosure.

Among those benefits and improvements that have been disclosed, other objects and advantages of this disclosure will become apparent from the following description taken in conjunction with the accompanying drawings. The drawings constitute a part of this specification and include exemplary embodiments of the present disclosure and illustrate various objects and features thereof.

### DETAILED DESCRIPTION

As required, detailed embodiments of the present disclosure are disclosed herein; however, it is to be understood that the disclosed embodiments are merely exemplary of the disclosure that may be embodied in various forms. The figures are not necessarily to scale, some features may be exaggerated to show details of particular components. Therefore, specific structural and functional details disclosed herein are not to be interpreted as limiting, but merely as a basis for the claims and as a representative basis for teaching one skilled in the art to variously employ the present disclosure.

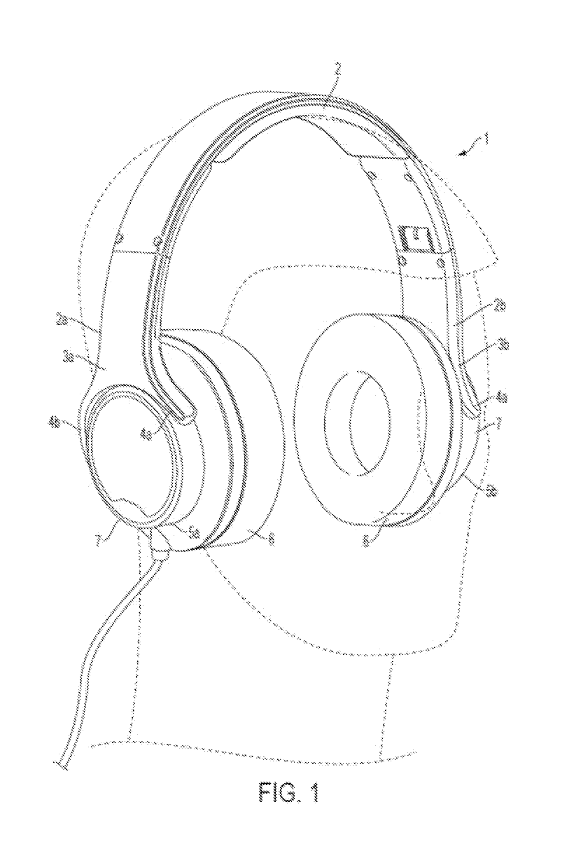

FIG. 1 illustrates the music listening and playing apparatus 1 of the present disclosure. The apparatus comprises a headband 2 having opposing ends, 2a and 2b respectively; at least two connectors, 3a and 3b respectively, each of the connectors has at least two arms, 4a and 4b respectively. The first arm 4a is shorter than a second arm 4b.

The apparatus 1 further comprises at least two speakers, 5a and 5b respectively, each of the speakers having opposing sides and comprising an audio output element 6 on a first side and a compartment 7 on a second side. The first and second arms, 4a and 4b, of each of the connectors is pivotally attached to a portion of each of the speakers, 5a or 5b, to thereby allow rotation of said speakers. Each of the audio output elements 6 of each of the speakers, 5a and 5b, generally face one another during a first listening mode. In the first listening mode, the headband 2 is situated around the user's head and the audio output element 6 of each of the speakers, 5a and 5b, are generally facing the user's ears.

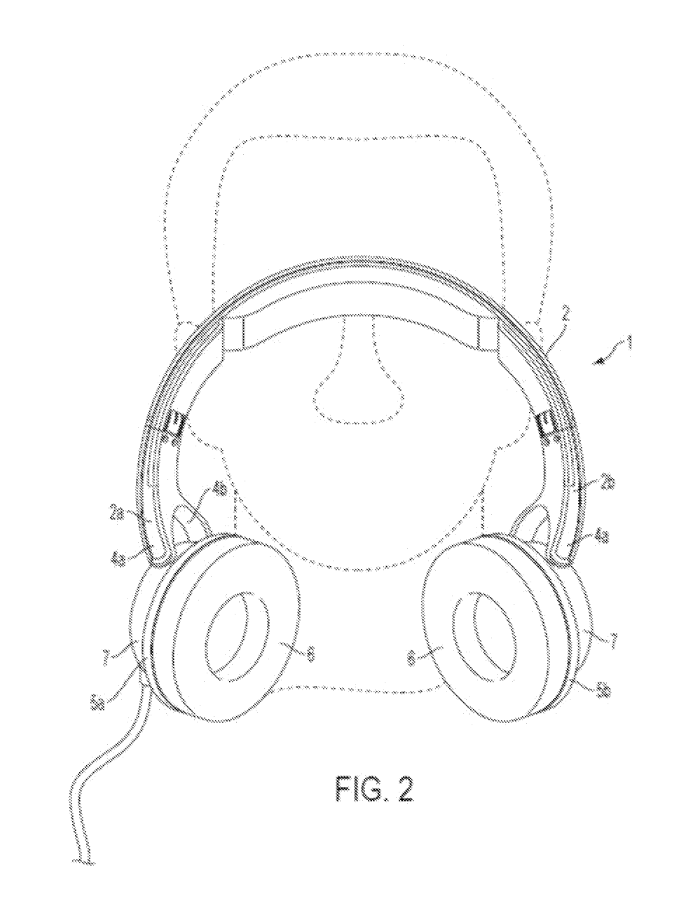

FIG. 2 depicts the second listening mode of the apparatus 1 of the present disclosure. The apparatus 1 may be placed around the user's neck. Each of the speakers, 5a and 5b, are rotatable about the first and second arms, 4a and 4b, of each of the connectors, 3a and 3b, to thereby allow each of the audio output elements 6 of each of the speakers, 5a and 5b, to turn away from one another during the second listening mode. The rotation of the speakers, 5a and 5b, allows for changes in modes.

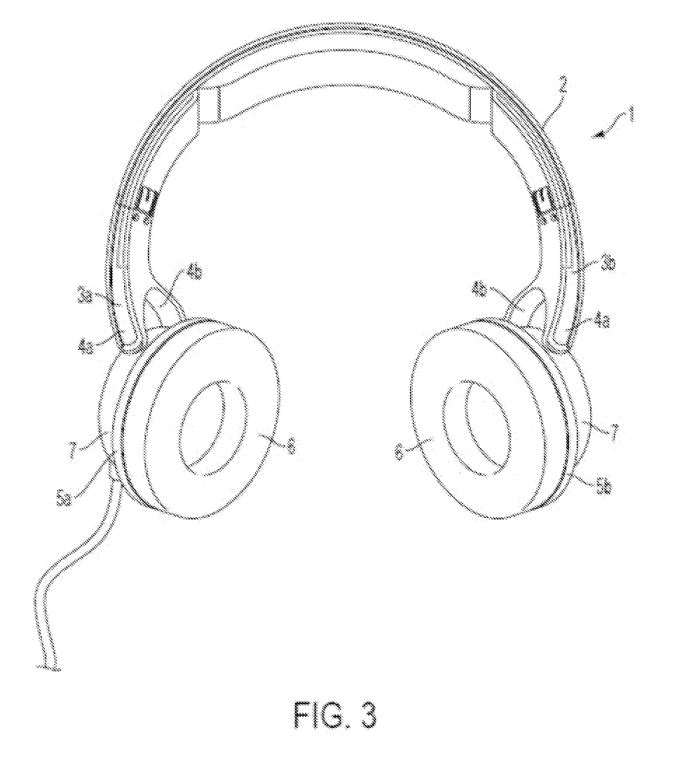

FIG. 3 shows another music playing mode where the apparatus 1 is set on a surface and the headband 2 is generally parallel to the surface 10 and the speakers, 5a and 5b, are designed to be rotated about the first and second arms, 4a and 4b, of each of the connectors, 3a and 3b, to allow the audio output elements 6 of each of the speakers, 5a and 5b, to generally face away from the surface 10 during the second listening mode.

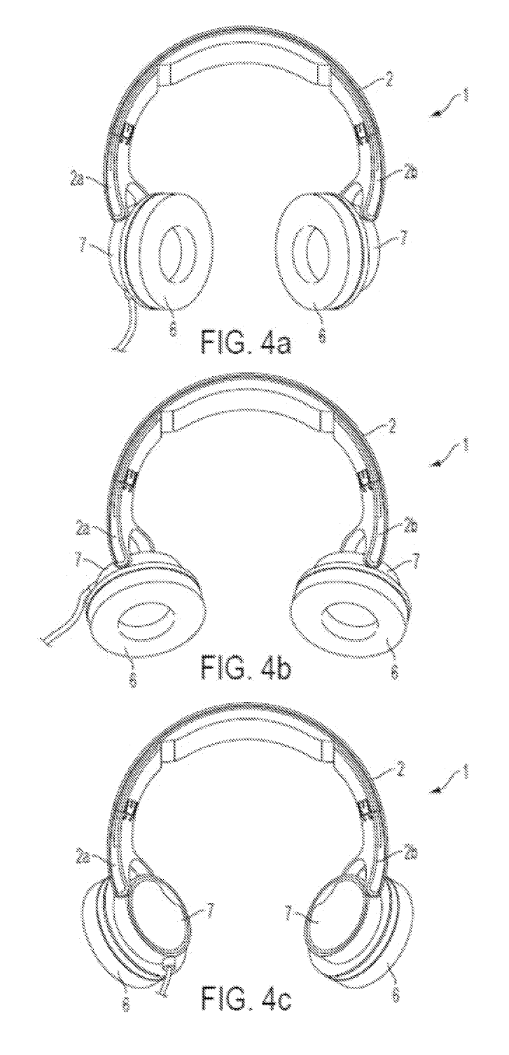

FIGS. 4a-c illustrates the rotation of the speaker, 5a and 5b. During the music listening mode, the audio output element 6 of the speaker 5a is generally facing inward as shown in FIG. 4a. The speaker 5a is rotated outwardly to activate the music playing mode as shown in FIG. 4b. In the music playing mode, the speaker 5a may be adjusted for optimum sound as shown in FIG. 4c. The speaker 5 may then be rotated back to its original position as shown in FIG. 4a to return to the music listening mode.

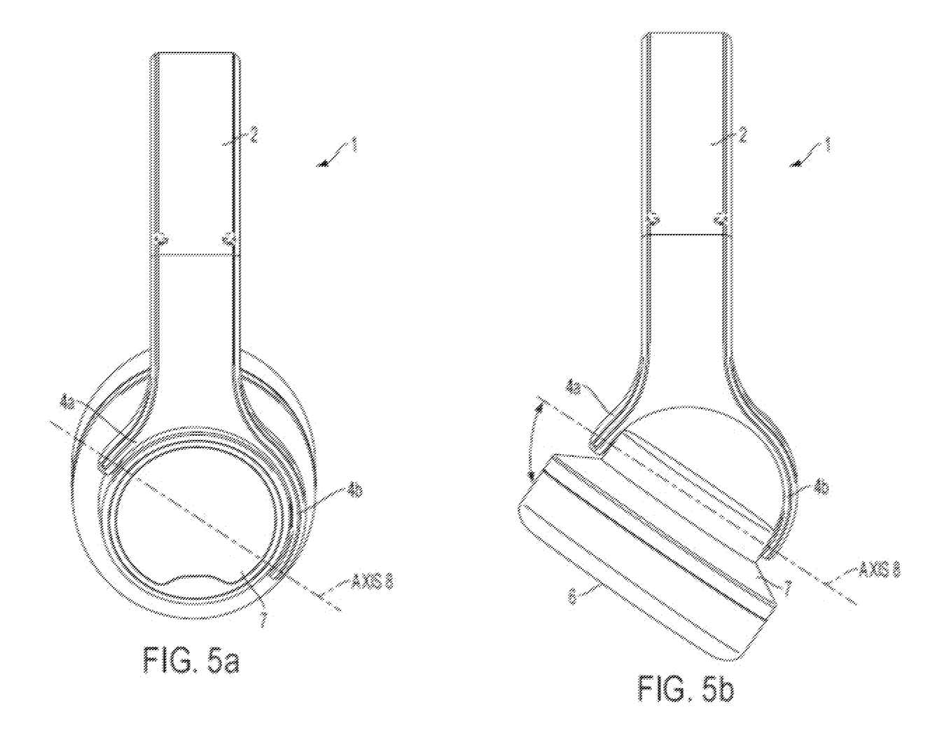

Each of the speakers, 5a and 5b, rotates about an axis 8 formed by the first and second arms, 4a and 4b, of each of the connectors, 3a and 3b. Each of the speakers, 5a and 5b, is designed to rotate about the axis 8 during the first listening mode at angles from about 0 degrees to about 100 degrees as shown in FIG. 5a.

Each of the speakers, 5a and 5b, is designed to rotate about the axis 8 during the second listening mode at angles from about 20 degrees to greater than 180 degrees as shown in FIG. 5b.

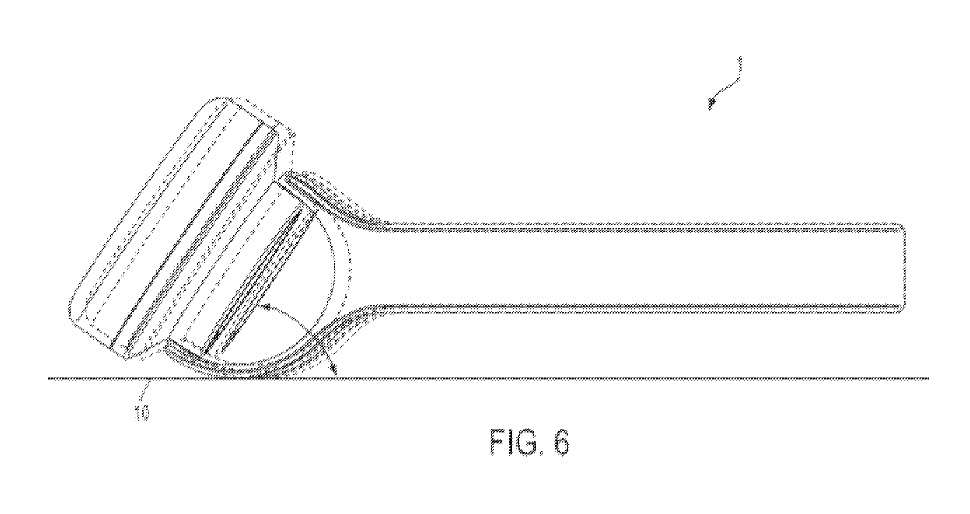

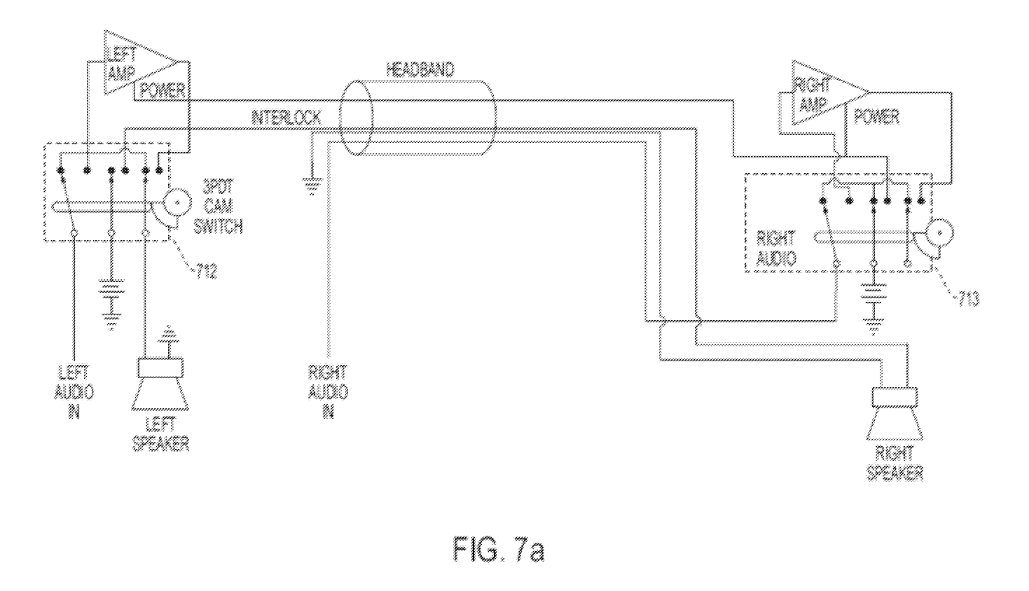

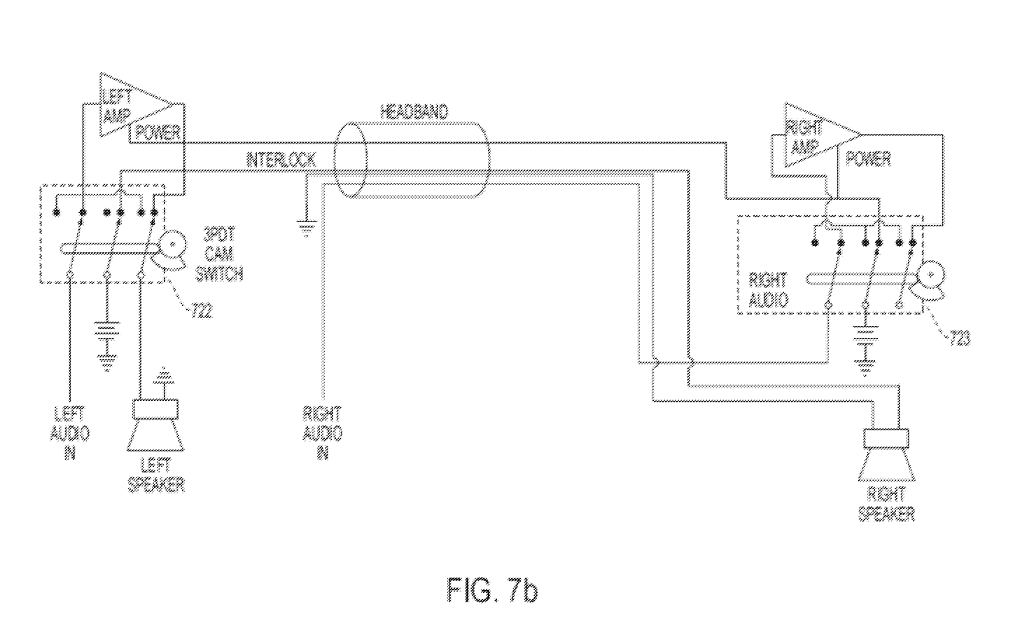

FIG. 6 shows that differing the length ratios of the arms, 4a and 4b, create different angles between the speaker 5a and surface 10. The length of the second arm 4b relative to the first arm 4a creates an angle between the surface 10 and at least one speaker 5, and the angle is greater than 1 degree and less than 90 degrees. FIGS. 7a-b are schematic diagrams of one of the embodiments of the circuitry of the present disclosure. In this embodiment, the cam switch 712 (shown schematically) has three contacts on the input, and six on the output (a three pole double throw switch—3PDT).

When the axle is not rotated and the product is worn as a headset, the switch connects the left audio channel directly to the left speaker, and the right audio channel to the right speaker, and does not route power to the amplifier. The music device powers the acoustic transducer directly. The cam's profile determines the angle at which the switch is activated, and thus the angle at which the mode is switched from headset mode to speaker mode. In this example, the cam is set at 30 degrees, but could be set anywhere from 20 to 110 degrees.

In this example, once the enclosures are rotated by more than 30 degrees, the two 3PDT switches 722 and 723 are thrown closed. This now routes the left audio signal to the left amplifier and the output of the left amplifier to the left speaker (and similarly for the right channel). It also provides power to the amplifier by running the power through the right enclosure switch in series—thus assuring both switches must be closed (and thus the speakers aimed safely away from the ears) before energizing the amplifier.

There are other variations and embodiments of the circuit. In another embodiment, the switch could contain one input and one output, used to trigger a solid state relay that provides all the aforementioned audio and power routing. In a further embodiment, the switch might be used to control the volume level, so it is low as a headset and high as a speaker. Embodiments of the present disclosure can be used with any applicable circuitry and is not limited to the circuitry shown in FIGS. 7A and 7B.

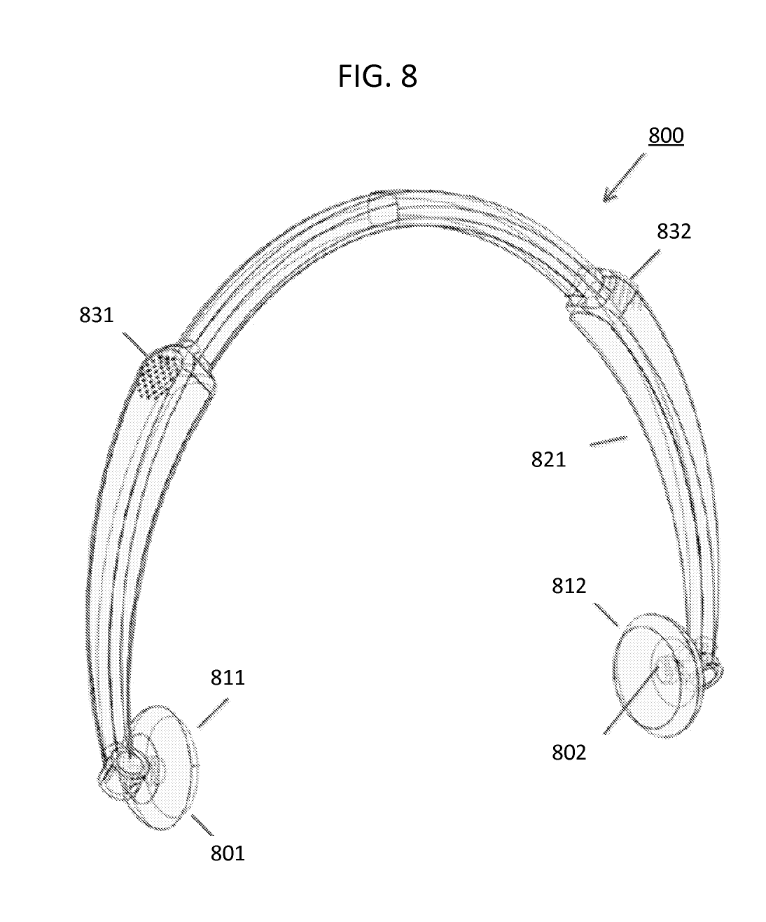

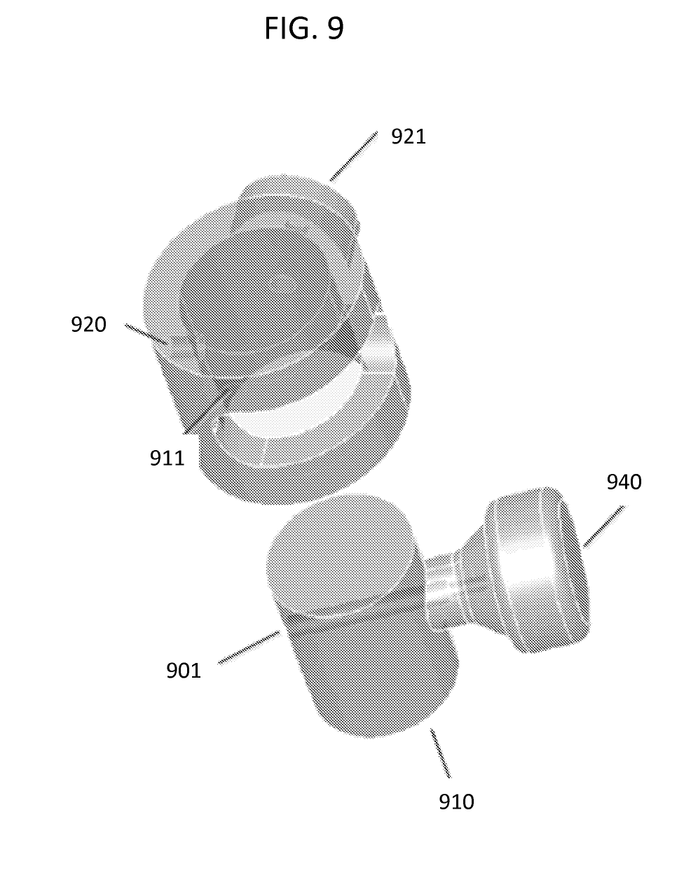

According to embodiments of the present disclosure rotation of the speaker enclosure of the headset mechanically activates a valve, thereby allowing air to flow through a different pathway when the headset is in the “speaker configuration.” As shown in FIG. 8, a headset 800 is provided including speakers 801 and 802. According to embodiment, the speakers 801, 802 may be sized to fit within an ear of a user and/or may be covered with an acoustic foam cushion 811 and 812. As shown in FIG. 9, a back portion of each speaker is vented by a tube 901 configured to enhance audio reproduction at low frequencies.

According to embodiments of the present disclosure, when the speakers are rotated (e.g., approximately 90 degrees), the vent tube 901 is mechanically redirected into a headband portion 820 and 821 (or horns) of FIG. 8. The headband portions 820, 821 include a hollow portion acting like an acoustic horn to amplify the sound of the speakers 801, 802. In an embodiment, each headband portion 820, 821 vents through a respective grille 831, 832, as shown in FIG. 8.

An exemplary rotary joint configured to enable a mechanically actuated valve is shown in FIG. 9. Much like a water valve, an inner core 910 fits within collinear bearing 911. In headset mode, air from speaker 940 passes from vent tube 901 to tube 920. In headphone mode, air from speaker 940 passes from vent tube 901 into tube 921 and then into the horns.

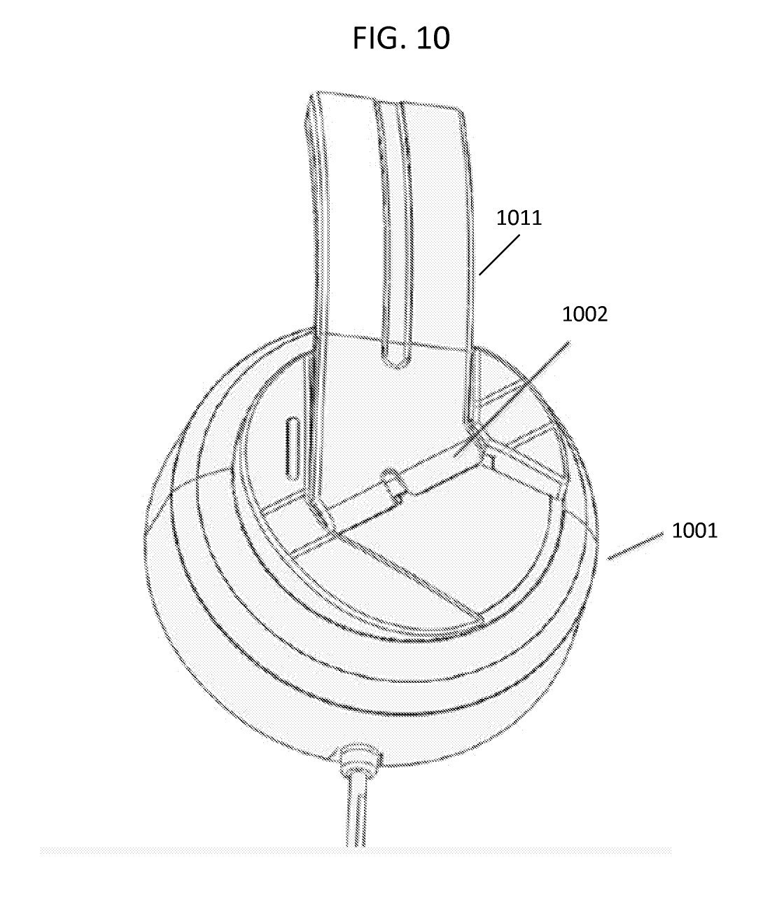

In an embodiment, the speakers may be electrically amplified and the movement of the speaker housing itself exposes an otherwise hidden and sealed vent. For example, as shown in FIG. 10, a headset is provided including a speaker enclosure 1001, a headband 1011 and an offset axle 1002 (e.g., at a 45 degree offset). An exemplary headset including an offset axle is described in detail in U.S. patent application Ser. No. 14/053,799, filed on Oct. 15, 2013, the entirety of which is incorporated by reference herein.

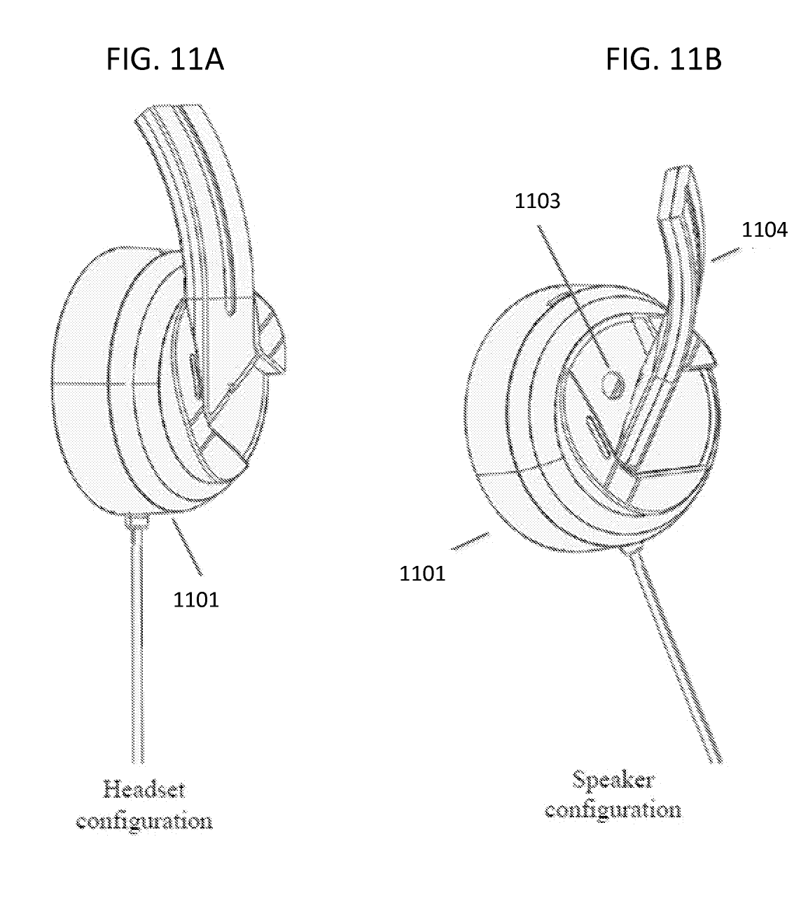

FIG. 11A illustrates a speaker enclosure 1101 in a headset or headphone configuration. FIG. 11B illustrates the speaker enclosure 1101 rotated approximately 90 degrees in the speaker configuration. The rotation from the position in FIG. 11A to the position in FIG. 11B exposes vent 1103 which was otherwise covered by headband portion 1104 and sealed with a gasket (not shown) when in the headset configuration. According to embodiments of the present disclosure, the venting position and acoustic properties may be adjusted by the mechanical rotation of the speaker enclosure 1101 acting as, or operating, a vent.

According to embodiments of the present invention, the speaker 1101 of the headset achieves a mechanically variable acoustic impedance wherein transitioning the speaker 401 from a headset configuration to a speaker configuration exposes the vent 1103, changing the airflow and adjusting the acoustic performance of the speaker 1101.

As used herein, the terms “example” and/or “exemplary” are utilized to mean serving as an example, instance, or illustration. For the avoidance of doubt, the subject matter disclosed herein is not limited by such examples. In addition, any aspect or design described herein as an “example” and/or “exemplary” is not necessarily to be construed as preferred or advantageous over other aspects or designs, nor is it meant to preclude equivalent exemplary structures and techniques known to those of ordinary skill in the art.

It is to be understood that the above description is intended to be illustrative, and not restrictive. Many other embodiments will be apparent to those of skill in the art upon reading and understanding the above description.

Numerous modifications and variations of the present disclosure are possible in light of the above teachings. It is therefore to be understood that within the scope of the attendant claims attached hereto, embodiments of the present disclosure may be practiced otherwise than as specifically disclosed herein.

What is claimed is:

1. A listening apparatus comprising:
at least one speaker housing having an acoustic impedance and configured for conversion between a first listening mode and a second listening mode by rotation of the at least one speaker housing about an axle;
at least one vent configured to alter the acoustic impedance of the at least one speaker housing; and
at least one valve, wherein the at least one valve is configured to open the at least one vent in the first listening mode and configured to close at least some portion of the at least one vent in the second listening mode.

2. The apparatus of claim 1 wherein operation of the valve is control by rotation of the at least one speaker housing about the axle.

3. The apparatus of claim 2 further comprising a headband and wherein at least one valve is formed by proximity of a portion of the headband to a portion of the at least one speaker housing.
